(19) United States
(12) Patent Application Publication
(10) Pub. No.: US 2026/0164427 A1
(43) Pub. Date: Jun. 11, 2026

(54) CONSECUTIVE UPLINK TRANSMISSION HANDLING

(71) Applicant: QUALCOMM Incorporated, San Diego, CA (US)

(72) Inventors: Yi HUANG, San Diego, CA (US); Jae Ho RYU, San Diego, CA (US); Peter GAAL, San Diego, CA (US); Timo Ville VINTOLA, San Diego, CA (US); Enoch Shiao-Kuang LU, San Diego, CA (US); Pranay Sudeep RUNGTA, New York, NY (US); Jing SUN, San Diego, CA (US); Jing JIANG, San Diego, CA (US)

(21) Appl. No.: 18/970,840

(22) Filed: Dec. 5, 2024

(51) Int. Cl. H04W 72/1268; H04W 72/51; H04W 72/566

(52) U.S. Cl. CPC H04W 72/1268; H04W 72/51; H04W 72/569

(57) ABSTRACT

Methods, systems, and devices for wireless communications are described. A user equipment (UE) may receive a control message that schedule a first uplink message via a first set of time resources and a second uplink message via a second set of time resources. The UE may refrain from transmitting at least a first portion of the first uplink message that is virtually overlapping (and physically non-overlapping) with the second uplink message (e.g., drop the first portion). In some aspects, the first portion of the first uplink message virtually overlaps with the second uplink message based on a time gap between the first uplink message and the second uplink message in the time domain being less than a threshold gap. The UE may then transmit the second uplink message, a second portion of the first uplink message that is virtually non-overlapping with the second uplink message, or both.

### TECHNICAL FIELD

The following relates to wireless communications, including techniques for consecutive uplink transmission handling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network entity, one or more control messages scheduling a first uplink message via a first set of time resources and a second uplink message via a second set of time resources, where the second set of time resources is physically non-overlapping with the first set of time resources in a time domain, refraining from transmitting at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap, and transmitting the second uplink message, a second portion of the first uplink message that is virtually non-overlapping with the second uplink message, or both, based on refraining from transmitting the first portion of the first uplink message.

A UE for wireless communications is described. The UE may include one or more memories storing processor executable code, and one or more processors coupled with the one or more memories. The one or more processors may individually or collectively be operable to execute the code to cause the UE to receive, from a network entity, one or more control messages scheduling a first uplink message via a first set of time resources and a second uplink message via a second set of time resources, where the second set of time resources is physically non-overlapping with the first set of time resources in a time domain, refrain from transmitting at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap, and transmit the second uplink message, a second portion of the first uplink message that is virtually non-overlapping with the second uplink message, or both, based on refraining from transmitting the first portion of the first uplink message.

Another UE for wireless communications is described. The UE may include means for receiving, from a network entity, one or more control messages scheduling a first uplink message via a first set of time resources and a second uplink message via a second set of time resources, where the second set of time resources is physically non-overlapping with the first set of time resources in a time domain, means for refraining from transmitting at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap, and means for transmitting the second uplink message, a second portion of the first uplink message that is virtually non-overlapping with the second uplink message, or both, based on refraining from transmitting the first portion of the first uplink message.

A non-transitory computer-readable medium storing code for wireless communications is described. The code may include instructions executable by one or more processors (e.g., directly, indirectly, after pre-processing, without pre-processing) to receive, from a network entity, one or more control messages scheduling a first uplink message via a first set of time resources and a second uplink message via a second set of time resources, where the second set of time resources is physically non-overlapping with the first set of time resources in a time domain, refrain from transmitting at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap, and transmit the second uplink message, a second portion of the first uplink message that is virtually non-overlapping with the second uplink message, or both, based on refraining from transmitting the first portion of the first uplink message.

In some examples of the method, UEs, and non-transitory computer-readable medium described herein, the UE refrains from transmitting the first portion of the first uplink message in accordance with a transmission configuration for transmitting temporally-overlapping uplink messages.

In some examples of the method, UEs, and non-transitory computer-readable medium described herein, refraining from transmitting at least the first portion of the first uplink message may include operations, features, means, or instructions for refraining from transmitting at least the first portion of the first uplink message based on a first priority of the first uplink message being less than a second priority of the second uplink message.

In some examples of the method, UEs, and non-transitory computer-readable medium described herein, transmitting the second uplink message, the second portion of the first uplink message, or both may include operations, features, means, or instructions for multiplexing the second portion of the first uplink message with the second uplink message based on a first priority of the first uplink message being less than a second priority of the second uplink message, where the first uplink message includes an uplink control channel message and the second uplink message includes an uplink shared channel message.

Some examples of the method, UEs, and non-transitory computer-readable medium described herein may further include operations, features, means, or instructions for transmitting, to the network entity, capability signaling indicating one or more capabilities of the UE to support transmission of the first uplink message and the second uplink message in accordance with the threshold gap.

In some examples of the method, UEs, and non-transitory computer-readable medium described herein, the threshold gap may be based on a subcarrier spacing of a channel associated with the first uplink message, the second uplink message, or both.

In some examples of the method, UEs, and non-transitory computer-readable medium described herein, transmitting the second uplink message, the second portion of the first uplink message, or both may include operations, features, means, or instructions for transmitting the second uplink message and refraining from transmitting the second portion of the first uplink message that may be virtually non-overlapping with the second uplink message.

In some examples of the method, UEs, and non-transitory computer-readable medium described herein, the first uplink message may be associated with a first uplink transmission type that supports full dropping of an entirety of the first uplink message and refraining from transmitting the second portion of the first uplink message may be based on the first uplink message being associated with the first uplink transmission type.

In some examples of the method, UEs, and non-transitory computer-readable medium described herein, the first uplink transmission type further includes an uplink shared channel transmission and a first symbol of the uplink shared channel transmission includes a demodulation reference signal (DMRS); an uplink control channel transmission associated with multiple UE scheduling supporting orthogonal covering code in the time domain; or a repetition of a sounding reference signal (SRS) with orthogonal covering code in the time domain.

In some examples of the method, UEs, and non-transitory computer-readable medium described herein, the first uplink message may be associated with a second uplink transmission type that supports partial dropping of the first uplink message and the method, apparatuses, and non-transitory computer-readable medium may include further operations, features, means, or instructions for transmitting the second portion of the first uplink message based on the first uplink message being associated with the second uplink transmission type.

In some examples of the method, UEs, and non-transitory computer-readable medium described herein, the UE refrains from transmitting at least the first portion of the first uplink message based on the first uplink message including an enhanced mobile broadband (eMBB) message and the second uplink message including an ultra-reliable low latency communications (URLLC) message.

In some examples of the method, UEs, and non-transitory computer-readable medium described herein, the first uplink message occurs prior to the second uplink message in the time domain, the first portion of the first uplink message includes an ending portion of the first uplink message, the first uplink message occurs subsequent to the second uplink message in the time, and the first portion of the first uplink message includes a beginning portion of the first uplink message.

In some examples of the method, UEs, and non-transitory computer-readable medium described herein, the first uplink message may be associated with a first transmission power at the UE, the second uplink message may be associated with a second transmission power at the UE, and the first portion of the first uplink message virtually overlaps with the second uplink message based on a difference between the first transmission power and the second transmission power being greater than a threshold difference.

In some examples of the method, UEs, and non-transitory computer-readable medium described herein, the first uplink message may be associated with a first transmit antenna of the UE, the second uplink message may be associated with a second transmit antenna of the UE, and first portion of the first uplink message virtually overlaps with the second uplink message based on the first transmit antenna being different from the second transmit antenna.

A method for wireless communications by a network entity is described. The method may include outputting, to a UE, one or more control messages scheduling a first uplink message via a first set of time resources and a second uplink message via a second set of time resources, where the second set of time resources is physically non-overlapping with the first set of time resources in a time domain, refraining from monitoring for at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap, and obtaining the second uplink message, a second portion of the first uplink message that is virtually non-overlapping with the second uplink message, or both, based on refraining from monitoring for at least the first portion of the first uplink message.

A network entity for wireless communications is described. The network entity may include one or more memories storing processor executable code, and one or more processors coupled with the one or more memories. The one or more processors may individually or collectively be operable to execute the code to cause the network entity to output, to a UE, one or more control messages scheduling a first uplink message via a first set of time resources and a second uplink message via a second set of time resources, where the second set of time resources is physically non-overlapping with the first set of time resources in a time domain, refrain from monitoring for at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap, and obtain the second uplink message, a second portion of the first uplink message that is virtually non-overlapping with the second uplink message, or both, based on refraining from monitoring for at least the first portion of the first uplink message.

Another network entity for wireless communications is described. The network entity may include means for outputting, to a UE, one or more control messages scheduling a first uplink message via a first set of time resources and a second uplink message via a second set of time resources, where the second set of time resources is physically non-overlapping with the first set of time resources in a time domain, means for refraining from monitoring for at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap, and means for obtaining the second uplink message, a second portion of the first uplink message that is virtually non-overlapping with the second uplink message, or both, based on refraining from monitoring for at least the first portion of the first uplink message.

A non-transitory computer-readable medium storing code for wireless communications is described. The code may include instructions executable by one or more processors (e.g., directly, indirectly, after pre-processing, without pre-processing) to output, to a UE, one or more control messages scheduling a first uplink message via a first set of time resources and a second uplink message via a second set of time resources, where the second set of time resources is physically non-overlapping with the first set of time resources in a time domain, refrain from monitoring for at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap, and obtain the second uplink message, a second portion of the first uplink message that is virtually non-overlapping with the second uplink message, or both, based on refraining from monitoring for at least the first portion of the first uplink message.

In some examples of the method, network entities, and non-transitory computer-readable medium described herein, the network entity refrains from monitoring for the first portion of the first uplink message in accordance with a transmission configuration for communicating temporally-overlapping uplink messages.

In some examples of the method, network entities, and non-transitory computer-readable medium described herein, refraining monitoring for at least the first portion of the first uplink message may include operations, features, means, or instructions for refraining from monitoring for at least the first portion of the first uplink message based on a first priority of the first uplink message being less than a second priority of the second uplink message.

In some examples of the method, network entities, and non-transitory computer-readable medium described herein, obtaining the second uplink message, the second portion of the first uplink message, or both may include operations, features, means, or instructions for obtaining the second portion of the first uplink message that may be multiplexed with the second uplink message based on a first priority of the first uplink message being less than a second priority of the second uplink message, where the first uplink message includes an uplink control channel message and the second uplink message includes an uplink shared channel message.

Some examples of the method, network entities, and non-transitory computer-readable medium described herein may further include operations, features, means, or instructions for obtaining, from the UE, capability signaling indicating one or more capabilities of the UE to support transmission of the first uplink message and the second uplink message in accordance with the threshold gap.

In some examples of the method, network entities, and non-transitory computer-readable medium described herein, the threshold gap may be based on a subcarrier spacing of a channel associated with the first uplink message, the second uplink message, or both.

In some examples of the method, network entities, and non-transitory computer-readable medium described herein, obtaining the second uplink message, the second portion of the first uplink message, or both may include operations, features, means, or instructions for obtaining the second uplink message and refraining from monitoring for the second portion of the first uplink message that may be virtually non-overlapping with the second uplink message.

In some examples of the method, network entities, and non-transitory computer-readable medium described herein, the first uplink message may be associated with a first uplink transmission type that supports full dropping of an entirety of the first uplink message and refraining from monitoring for the second portion of the first uplink message may be based on the first uplink message being associated with the first uplink transmission type.

In some examples of the method, network entities, and non-transitory computer-readable medium described herein, the first uplink transmission type may include operations, features, means, or instructions for an uplink shared channel transmission, where a first symbol of the uplink shared channel transmission includes a DMRS; an uplink control channel transmission associated with multiple UE scheduling supporting orthogonal covering code in the time domain; or a repetition of a SRS with orthogonal covering code in the time domain.

In some examples of the method, network entities, and non-transitory computer-readable medium described herein, the first uplink message may be associated with a second uplink transmission type that supports partial dropping of the first uplink message and the method, apparatuses, and non-transitory computer-readable medium may include further operations, features, means, or instructions for monitoring for the second portion of the first uplink message based on the first uplink message being associated with the second uplink transmission type.

In some examples of the method, network entities, and non-transitory computer-readable medium described herein, the network entity refrains from obtaining at least the first portion of the first uplink message based on the first uplink message including an eMBB message and the second uplink message including an URLLC message.

In some examples of the method, network entities, and non-transitory computer-readable medium described herein, the first uplink message occurs prior to the second uplink message in the time domain, the first portion of the first uplink message includes an ending portion of the first uplink message, the first uplink message occurs subsequent to the second uplink message in the time domain, and the first portion of the first uplink message includes a beginning portion of the first uplink message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support techniques for consecutive uplink transmission handling in accordance with one or more aspects of the present disclosure.

FIG. 3 shows example uplink scheduling configurations that support techniques for consecutive uplink transmission handling in accordance with one or more aspects of the present disclosure.

FIG. 4 shows an example of a process flow that supports techniques for consecutive uplink transmission handling in accordance with one or more aspects of the present disclosure.

FIGS. 5 and 6 show block diagrams of devices that support techniques for consecutive uplink transmission handling in accordance with one or more aspects of the present disclosure.

FIG. 7 shows a block diagram of a communications manager that supports techniques for consecutive uplink transmission handling in accordance with one or more aspects of the present disclosure.

FIG. 8 shows a diagram of a system including a device that supports techniques for consecutive uplink transmission handling in accordance with one or more aspects of the present disclosure.

FIGS. 9 and 10 show block diagrams of devices that support techniques for consecutive uplink transmission handling in accordance with one or more aspects of the present disclosure.

FIG. 11 shows a block diagram of a communications manager that supports techniques for consecutive uplink transmission handling in accordance with one or more aspects of the present disclosure.

FIG. 12 shows a diagram of a system including a device that supports techniques for consecutive uplink transmission handling in accordance with one or more aspects of the present disclosure.

FIGS. 13 through 15 show flowcharts illustrating methods that support techniques for consecutive uplink transmission handling in accordance with one or more aspects of the present disclosure.

### DETAILED DESCRIPTION

In some wireless communications systems, a network entity may schedule a user equipment (UE) with temporally-overlapping (e.g., physically-overlapping) uplink messages. For example, the network entity may schedule a first uplink message for the UE to transmit, and may also schedule a second, higher-priority uplink message for the UE to transmit that at least partially overlaps in time with the first uplink message. In such implementations, the temporal overlap of the scheduled uplink messages may result in a scheduling conflict which the UE may resolve by dropping (e.g., refraining from transmitting) the entirety of the first message or a portion of the first message (e.g., the lower priority message) based on a set of priority rules.

Additionally, or alternatively, the network entity may schedule the UE to perform back-to-back (e.g., consecutive) uplink transmissions, which may occur without a time gap or a relatively short time gap occurring between the uplink messages. Even though the back-to-back uplink messages do not physically overlap in time, the scheduling of back-to-back uplink message may still cause challenges for the UE. For example, due to the absence of a time gap between the uplink messages (or a relatively short gap that is less than a threshold gap), the UE may be unable to perform the back-to-back uplink transmissions if the UE is expected to transmit the uplink messages using different transmit (Tx) antennas, or if the back-to-back uplink transmissions are associated with different transmission powers. Some such back-to-back uplink messages at the UE may result in a “virtual overlap” or “virtual conflict” at the UE. For example, the virtual overlap may occur when the UE is scheduled with consecutive uplink transmissions that require the UE to switch transmit antennas, and/or consecutive uplink transmissions that require the UE to change transmission powers.

In order to support efficient communication for consecutive uplink transmissions that are virtually overlapping, the UE may support one or more rules or configurations for dropping and/or prioritizing the consecutive uplink transmissions (e.g., back-to-back transmissions). For example, the UE may support one or more dropping configurations and/or prioritization rules that may allow the UE to drop at least a portion of an uplink message that “virtually overlaps” with another uplink message, even if the respective uplink messages do not physically overlap in time. For example, the UE may be scheduled to transmit a first uplink message and a second uplink message, where the first and second uplink messages are non-overlapping in time (e.g., no physical overlap), but where such uplink messages “virtually overlap” based on a gap between the uplink messages being less than some threshold (e.g., based on the uplink messages being “back-to-back” with no time gap between). In such cases, the UE may drop all or a portion of the first or second uplink message in order to resolve the virtual conflict. In some cases, the UE may utilize various prioritization rules to determine which uplink message to partially or fully drop in order to resolve the virtual conflict between the virtually-overlapping uplink messages.

Aspects of the disclosure may be implemented to realize one or more potential advantages. For example, by implementing various dropping configurations, the UE may be able to effectively handle back-to-back uplink transmissions (e.g., resolve virtual conflicts) without reducing device performance. For example, in some cases, the UE may implement a transition time at the end of an uplink transmission in order to prepare for transmission of the next consecutive uplink transmission. But this transition time may impact the transmission of the first uplink message while reducing overall uplink performance. The techniques described herein may eliminate the transition time between consecutive uplink transmissions, which may allow for improved uplink transmission quality. Additionally, or alternatively, the techniques described herein may support improved reliability based on prioritization of higher priority uplink transmissions that are virtually overlapping with lower priority transmissions.

Aspects of the disclosure are initially described in the context of wireless communications systems. Aspects of the disclosure are further illustrated by and described with reference to uplink scheduling configurations, a process flow, apparatus diagrams, system diagrams, and flowcharts that relate to techniques for consecutive uplink transmission handling.

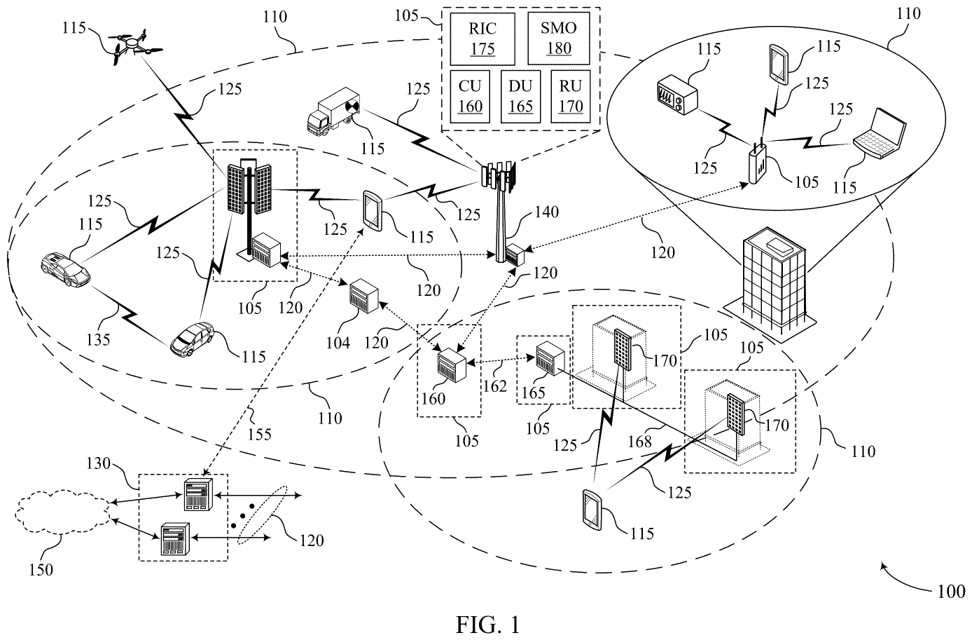

FIG. 1 shows an example of a wireless communications system 100 that supports techniques for consecutive uplink transmission handling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for consecutive uplink transmission handling as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may be a device such as a cellular phone, a smart phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some aspects, a network entity 105 of the wireless communications system 100 may schedule a UE 115 to perform back-to-back (e.g., consecutive) uplink transmissions. Even though the back-to-back uplink messages may not physically overlap in time, the scheduling of back-to-back uplink message may still cause challenges for the UE 115. For example, due to the absence of a time gap between the uplink messages (or a relatively short gap that is less than a threshold gap), the UE 115 may be unable to perform the back-to-back uplink transmissions if the UE 115 is expected to transmit the uplink messages using different Tx antennas, or if the back-to-back uplink transmission are associated with different transmission powers. Some such back-to-back uplink messages at the UE 115 may result in a “virtual overlap” or “virtual conflict” at the UE 115. For example, the virtual overlap may occur when the UE is scheduled with consecutive uplink transmissions that require the UE 115 to switch transmit antennas, and/or consecutive uplink transmissions that require the UE 115 to change transmission powers.

In order to support efficient communication for consecutive uplink transmissions that are virtually overlapping, the UE 115 may support one or more rules or configurations for dropping and/or prioritizing the consecutive uplink transmissions. For example, the UE 115 may support one or more dropping configurations and/or prioritization rules that may allow the UE 115 to drop at least a portion of an uplink message that “virtually overlaps” with another uplink message, even if the respective uplink messages do not physically overlap in time. For example, the UE 115 may be scheduled to transmit a first uplink message and a second uplink message, where the first and second uplink messages are non-overlapping in time (e.g., no physical overlap). In such cases, the UE 115 may drop all or a portion of the first or second uplink message in order to resolve the virtual conflict.

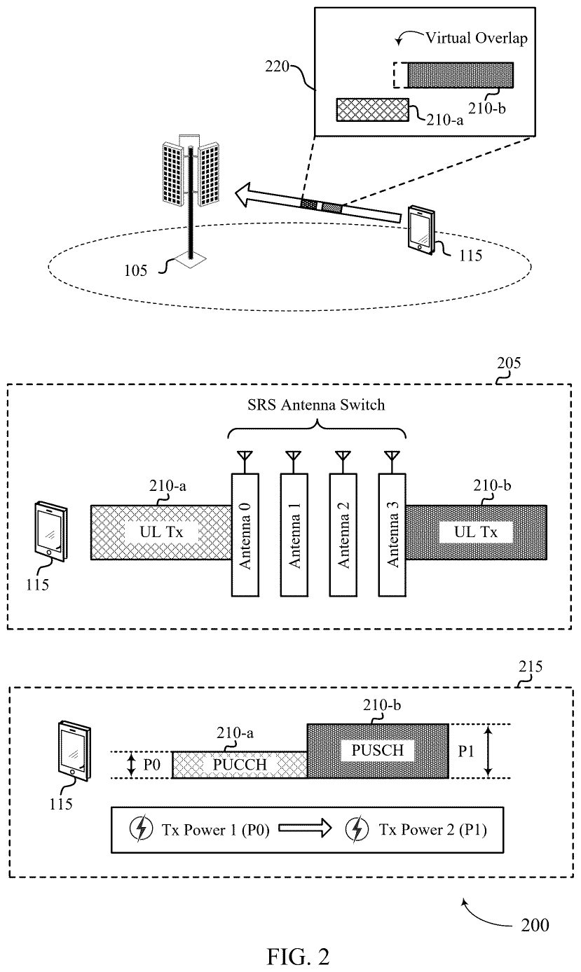

FIG. 2 shows an example of a wireless communications system 200 that supports techniques for consecutive uplink transmission handling in accordance with one or more aspects of the present disclosure. For example, the wireless communications system 200 may support communications (including uplink transmissions) occurring between a network entity 105 and a UE 115, each of which may be examples of network entities 105 and UEs 115 described herein.

In some implementations, the network entity 105 may schedule the UE 115 with transmissions of temporally-overlapping uplink messages. For example, the network entity 105 may schedule a first uplink message for the UE 115 to transmit, then may schedule a second, higher-priority uplink message for the UE 115 to transmit that overlaps in time with the first uplink message. In such implementations, the first and second uplink messages may physically overlap (or temporally overlap), resulting in a scheduling conflict. In some examples, to resolve the scheduling conflict, the UE 115 may be configured to drop (e.g., refrain from transmitting) the entirety of the first message or a portion of the first message (e.g., the lower priority message) based on a set of priority rules. For example, the UE 115 may prioritize low latency and/or high reliability communications (such as URLLC communications) before lower priority communications, such as eMBB communications and massive machine-type (MMTC) communications.

In some other implementations, the network entity 105 may schedule the UE 115 to perform back-to-back (e.g., consecutive) uplink messages, which may occur when there is an absence of a time gap or a relatively short time gap (e.g., a time gap that is shorter than a threshold time gap based on UE capabilities) occurring between the uplink messages. Even though the back-to-back uplink messages do not physically overlap in time, the scheduling of back-to-back uplink message may still cause challenges for the UE 115. For example, due to the absence of a time gap between the uplink messages (or a relatively short gap that is less than a threshold gap), the UE 115 may be unable to perform the back-to-back messages if the UE 115 is expected to transmit the uplink messages using different Tx antennas. That is, the UE 115 may be expected to perform physical antenna changes/switches between uplink transmissions, which may result in virtual conflicts. Gap symbols may be defined among sounding reference signal (SRS) antenna switch ports, but not before/after SRS antenna switch, which may result in virtual conflicts. That is, during SRS antenna switching (shown in uplink transmission configuration 205), the UE 115 may be configured with gap symbols between SRS antenna switch ports, so that the UE 115 may switch between SRS transmissions using SRS antenna 0, SRS antenna 1, SRS antenna 2, and SRS antenna 3. Some wireless communications systems define transition times to account for uplink messages that are scheduled immediately before or after SRS antenna switches, but such gap times may affect the transmission quality of the SRS transmissions and/or adjacent uplink messages.

Uplink transmission configuration 205 illustrates such a scenario, in which the UE 115 may transmit a first uplink message 210-a which is back-to-back with a SRS transmission using SRS antenna 0. In some aspects, since there is no time gap (e.g., symbol gap) between the first uplink message 210-a and the first SRS uplink transmission using Tx antenna 0, the UE 115 may be unable to transmit both the first uplink message 210-a and the first SRS uplink transmission if the UE 115 uses an antenna different from SRS antenna 0 for transmission of the first uplink message 210-a. That is, the UE 115 may lack sufficient time or capabilities to switch antennas between transmissions of the first uplink message 210-a and the first SRS uplink transmission if the uplink transmissions are back-to-back. Similarly, the UE 115 may be scheduled to perform a second SRS transmission using antenna 3 and a second uplink message 210-b that may use a different antenna than antenna 3. In this example, the UE 115 may be unable to transmit both the second SRS transmission (using antenna 3 ) and the second uplink message 210-b if the UE 115 uses an antenna different from SRS antenna 3 for transmission of the second uplink message 210-b. That is, the UE 115 may lack sufficient time or capabilities to switch antennas between transmissions of the first uplink message 210-a and the first SRS uplink transmission if the uplink transmissions are back-to-back.

Uplink transmission configuration 215 illustrates an additional or alternative scenario in which the UE 115 may be configured with back-to-back uplink messages that are to be transmitted using different UE transmit powers (e.g., b 0 and P1). For example, the UE 115 may transmit a first uplink message 210-a (e.g., a PUCCH) using a first transmit power (e.g., P0) followed by a second uplink message 210-b (e.g., a PUSCH) using a second transmit power (e.g., P1). In some such examples, if the UE 115 is not configured with a gap between uplink transmissions whose transmit power difference exceeds a threshold difference, the UE 115 may be unable to successfully change power amplifier states in time to transmit both uplink messages.

In some implementations, the scheduling of back-to-back uplink messages at the UE 115 may result in a “virtual overlap” or “virtual conflict” at the UE 115, even though the back-to-back messages do not actually physically overlap with one another. For example, the virtual overlap 220 may occur (or be defined as) when the UE 115 is scheduled with consecutive uplink transmissions that require the UE 115 to switch transmit antennas (shown in uplink transmission configuration 205), and/or consecutive uplink transmissions that require the UE 115 to change transmission power (shown in uplink transmission configuration 215). In some cases, the UE 115 may be configured with a transition time between the consecutive uplink transmissions, but in at least some aspects, the transition time may reduce the transmission quality of one or both of the consecutive uplink transmissions.

In order to support efficient communication for consecutive uplink transmissions that are virtually overlapping, the UE 115 may support one or more rules or configurations for dropping and/or prioritizing the consecutive uplink transmissions. For example, the UE 115 may support one or more dropping configurations and/or prioritization rules that may allow the UE 115 to drop at least a portion of an uplink message that “virtually overlaps” with another uplink message, even if the respective uplink messages do not physically overlap in time. That is, the UE 115 may support one or more rules or configurations for resolving the “virtual conflicts” illustrated in the uplink transmission configurations 205, 215.

For example, the UE 115 may be scheduled to transmit a first uplink message 210-a and a second uplink message 210-b, where the first and second uplink messages are non-overlapping in time (e.g., no physical overlap). The UE 115 may identify that the first and second uplink messages 210 virtually overlap with one another (e.g., the UE 115 may identify a virtual overlap) based on a time gap between the respective uplink messages 210 being less than a threshold gap. For instance, the first uplink message 210-a and the second uplink messages 210-b may virtually overlap one another if there is no gap between the end of the first uplink message 210-a and the start of the second uplink message 210-b (e.g., back-to-back). In such cases, the UE 115 may drop all or a portion of the first or second uplink message 210 in order to resolve the virtual conflict. In some cases, the UE 115 may utilize various prioritization rules to determine which uplink message 210 to partially or fully drop in order to resolve the virtual conflict between the virtually-overlapping uplink messages 210.

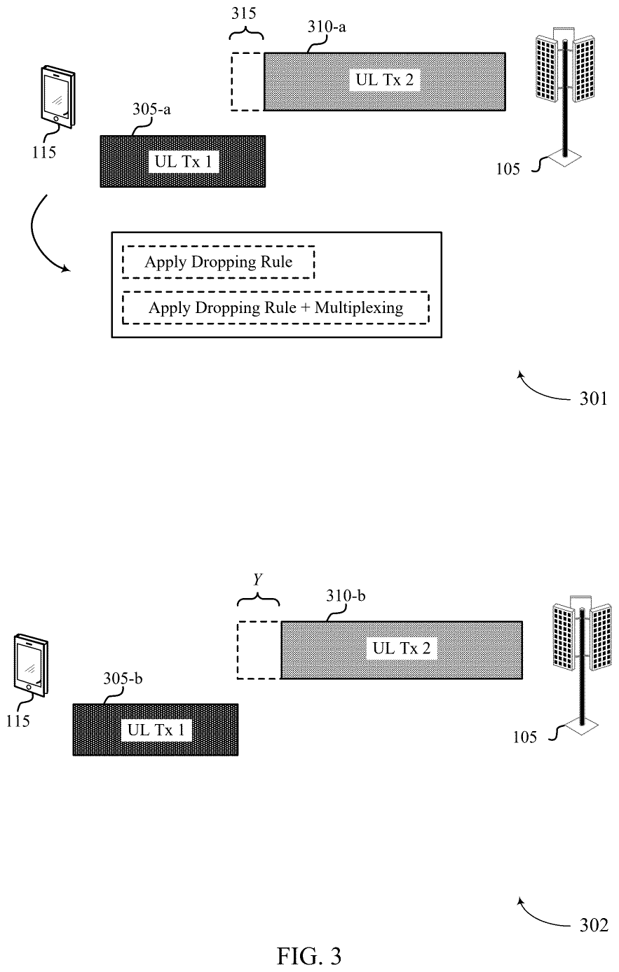

FIG. 3 shows examples of an uplink scheduling configuration 301 and an uplink scheduling configuration 302 that support techniques for consecutive uplink transmission handling in accordance with one or more aspects of the present disclosure. For example, the uplink scheduling configuration 301 and the uplink scheduling configuration 302 may support or illustrate communications (including uplink transmissions) occurring between a network entity 105 and a UE 115, each of which may be examples of network entities 105 and UEs 115 described herein.

The uplink scheduling configuration 301 illustrates a back-to-back uplink scheduling of a first uplink transmission 305-a (e.g., UL Tx 1) and a second uplink transmission 310-a (e.g., UL Tx 2). In some aspects, the UE 115 may identify a virtual overlap 315 between the first uplink transmission 305-a and the second uplink transmission 310-a based on the UE 115 performing an antenna switch between the first uplink transmission 305-a and the second uplink transmission 310-a (e.g., based on the first uplink transmission 305-a and the second uplink transmission 310-b being transmitted via different Tx antennas), or based on respective transmission powers for the first uplink transmission 305-a and the second uplink transmission 310-a being different, or both. In some examples, the virtual overlap 315 may include one or more ending uplink symbols of the first uplink transmission 305-a, or one or more starting uplink symbols of the second uplink transmission 310-a, or both.

In order to effectively handle the back-to-back uplink transmissions that are virtually overlapping, the UE 115 may implement one or more dropping rules to determine which uplink transmission to at least partially drop in order to address the virtual overlap 315. In some examples, the UE 115 may apply the same or similar dropping rules for uplink transmissions that are physically overlapping to the uplink transmissions that are virtually overlapping (e.g., a URLLC uplink transmission has a higher priority than an eMBB uplink transmission, which has a higher priority than an MMTC uplink transmission). In some implementations, the UE 115 may apply a dropping rule which indicates that the highest priority uplink transmission may cancel the lower priority uplink transmission. For example, if the UE 115 identifies the virtual overlap 315 between the first uplink transmission 305-a and the second uplink transmission 310-a, and determines that the first uplink transmission 305-a has a higher priority than the second uplink transmission 310-a, then the UE 115 may transmit the first uplink transmission 305-a and may drop (e.g., refrain from transmitting) at least a portion of the second uplink transmission 310-a.

In some other examples, if the first uplink transmission 305-a is a PUSCH message and the second uplink transmission 310-a is a PUCCH message, the UE 115 may multiplex (e.g., piggyback) the PUCCH message with the PUSCH message. In some cases, the UE 115 may drop the virtually overlapping symbols of the lower priority uplink transmission and multiplex the remaining OFDM symbols of the lower priority uplink transmission with the entire higher priority uplink transmission. That is, among two or more virtually overlapped uplink transmissions (e.g., the first uplink transmission 305-a and the second uplink transmission 310-a), the UE 115 may transmit the uplink transmission with the highest priority (or the highest uplink channel priority) and drop the remaining virtually overlapping OFDM symbols.

In some examples, when the UE 115 drops the virtually overlapped portion of the lower priority uplink message, the UE 115 may transmit the remaining non-overlapping portion of the lower priority uplink message. In such examples, the lower priority uplink transmission may be of an uplink transmission type that supports partial dropping. For example, the uplink transmission type that supports partial dropping may support dropping of the first or last OFDM symbol of the transmission without performance degradation due to the partial dropping.

In some other examples, when the UE 115 drops the virtually overlapped portion of the lower priority uplink message, the UE 115 may also drop the remaining non-overlapping portion of the lower priority uplink message. In such examples, the lower priority uplink transmission may be of an uplink transmission type that does not support partial dropping. For example, the uplink transmission type that does not support partial dropping may support only full dropping of the first or last OFDM symbol of the transmission. Some such uplink transmissions that are of the uplink transmission type that does not support partial dropping may include a PUSCH transmission with a front-loaded demodulation reference signal (DMRS) (e.g., the first OFDM symbol of the PUSCH transmission is a DMRS), a PUCCH that is for multi-UE scheduling on a same PUCCH transmission resource with orthogonal covering code in the time domain, an SRS repetition across time with orthogonal covering code in the time domain, or any combination thereof.

The uplink scheduling configuration 302 illustrates a back-to-back uplink scheduling of a first uplink transmission 305-b (e.g., UL Tx 1) and a second uplink transmission 310-b (e.g., UL Tx 2). In the example of uplink scheduling configuration 302, the UE 115 may not be configured to support virtual dropping, and in such examples, the network entity 105 may configure a symbol gap (e.g., Y) between the first uplink transmission 305-b and the second uplink transmission 310-b such that the UE 115 has sufficient time to switch antennas between uplink transmissions or adjust a power amplifier state between the uplink transmissions. In some implementations, the configured symbol gap Y may be a configured or fixed value determined by the network entity 105 based on the subcarrier spacing used for the uplink transmissions. In some examples, the network entity 105 may indicate multiple symbol gaps based on different possible subcarrier spacings. Additionally, or alternatively, the network entity 105 may configure the symbol gap Y based on information received in UE capability signaling. For example, the UE 115 may transmit one or more UE capability reports which indicate a symbol gap (e.g., a minimum symbol gap) that the UE 115 may support between consecutive uplink transmissions. The network entity 105 may utilize the UE capability information to configure the symbol gap Y between the first uplink transmission 305-b and the second uplink transmission 310-b.

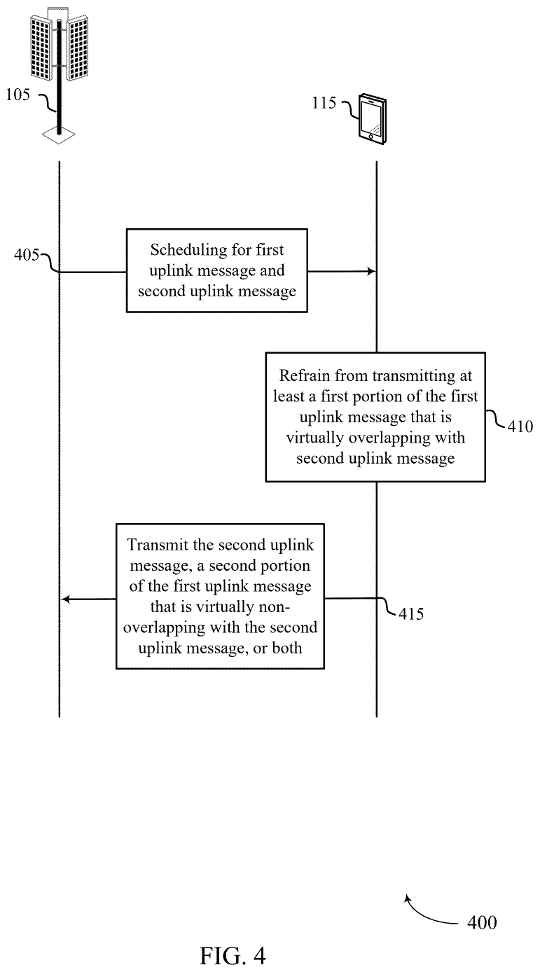

FIG. 4 shows an example of a process flow 400 that supports techniques for consecutive uplink transmission handling in accordance with one or more aspects of the present disclosure. The process flow 400 includes a UE 115 and a network entity 105, which may be examples of the corresponding devices as described herein. In the following description of the process flow 400, the operations between the UE 115 and the network entity 105 may be performed in a different order than the example order shown. Some operations may also be omitted from the process flow 400, and other operations may be added to the process flow 400. Further, although some operations or signaling may be shown to occur at different times for discussion purposes, these operations may actually occur at the same time.

At signal flow operation 405, the network entity 105 may transmit, and the UE 115 may receive, one or more control messages that schedule a first uplink message via a first set of time resources and a second uplink message via a second set of time resources. In some aspects, the second set of time resources may be physically non-overlapping with the first set of time resources in a time domain (e.g., temporally non-overlapping).

At signal flow operation 410, the UE 115 may refrain from transmitting (e.g., drop) at least a first portion of the first uplink message that is virtually overlapping with the second uplink message. In some aspects, the first portion of the first uplink message virtually overlaps with the second uplink message based on a time gap between the first uplink message and the second uplink message in the time domain being less than a threshold gap (e.g., the virtual overlap may be indicated or identified by the time gap between the first uplink message and the second uplink message being less than the threshold gap). In some examples, the UE 115 may refrain from transmitting the first portion of the first uplink message in accordance with a transmission configuration for transmitting temporally-overlapping uplink messages. For example, the UE 115 may apply one or more dropping rules used for temporally overlapping messages to the virtually overlapping first and second uplink messages.

In some aspects, the UE 115 may transmit one or more UE capability reports (e.g., UE capability signaling) which indicates one or more capabilities of the UE 115 to support transmission of the first uplink message and the second uplink message in accordance with the threshold gap. In some examples, one or more UE capability reports may indicate or include a time value of a time gap (e.g., a minimum time gap) that the UE 115 may support. In some examples, the threshold time gap may be based on a subcarrier spacing of the channel associated with the first uplink message, the second uplink message, or both.

At signal flow operation 415, the UE 115 may transmit the second uplink message, a second portion of the uplink message that is virtually non-overlapping with the second message, or both, based on refraining from transmitting the first portion of the first uplink message. In some examples, the UE 115 may refrain from transmitting (e.g., drop) at least the first portion of the first uplink message based on a first priority of the first uplink message being less than a second priority of the second uplink message (e.g., the first uplink message may be an eMBB message and the second uplink message may be a URLLC message with a higher priority). In some examples, the UE 115 may multiplex the second portion of the first uplink message with the second uplink message based on a first priority of the first uplink message being less than a second priority of the second uplink message. In some such examples, the first uplink message may be an uplink control channel message (e.g., a PUCCH) and the second uplink message may be an uplink shared channel message (e.g., a PUSCH).

In some examples, transmitting the second uplink message, the second portion of the uplink message that is virtually non-overlapping with the second message, or both, may include transmitting the second uplink message and refraining from transmitting the second portion of the first uplink message that is virtually non-overlapping with the second uplink message. In some such examples, the first uplink message may be associated with a first uplink transmission type that supports full dropping of an entirety of the first uplink message, and refraining from transmitting the second portion of the first uplink message may be based on the first uplink message being associated with the first uplink transmission type. In some aspects, the first uplink transmission type may include an uplink shared channel transmission (e.g., a PUSCH), that has a first symbol being a DMRS (e.g., a PUSCH with a front-loaded DMRS). In some aspects, the first uplink transmission type may be an uplink control channel transmission (e.g., a PUCCH) associated with a multi-UE scheduling that supports orthogonal covering code in the time domain. In some aspects, the first uplink transmission type may be a repetition of an SRS with orthogonal covering code in the time domain.

In some examples, the first uplink message may be associated with a second uplink transmission type that supports partial dropping of the first uplink message. In some such examples, the UE 115 may transmit the second portion of the first uplink message based on the first uplink message being associated with the second uplink transmission type.

In some examples, the first uplink message may occur prior to the second uplink message in the time domain, and the first portion of the first uplink message may include an ending portion of the first uplink message. Additionally, or alternatively, the first uplink message may occur subsequent to the second uplink message in the time domain, and the first portion of the first uplink message may include a beginning portion of the first uplink message. In some examples, the first uplink message may be associated with a first transmission power at the UE 115, and the second uplink message may be associated with a second transmission power at the UE 115. In some such examples, the first portion of the first uplink message virtually overlaps with the second uplink message (or may be determined as virtually overlapping with the second uplink message) based on a difference between the first transmission power and the second transmission power being greater than a threshold difference. Additionally, or alternatively, the first uplink message may be associated with a first transmit antenna of the UE 115, and the second uplink message may be associated with a second transmit antenna of the UE 115. In some such examples, the first portion of the first uplink message virtually overlaps with the second uplink message (or may be determined as virtually overlapping with the second uplink message) based on the first transmit antenna being different from the second transmit antenna.

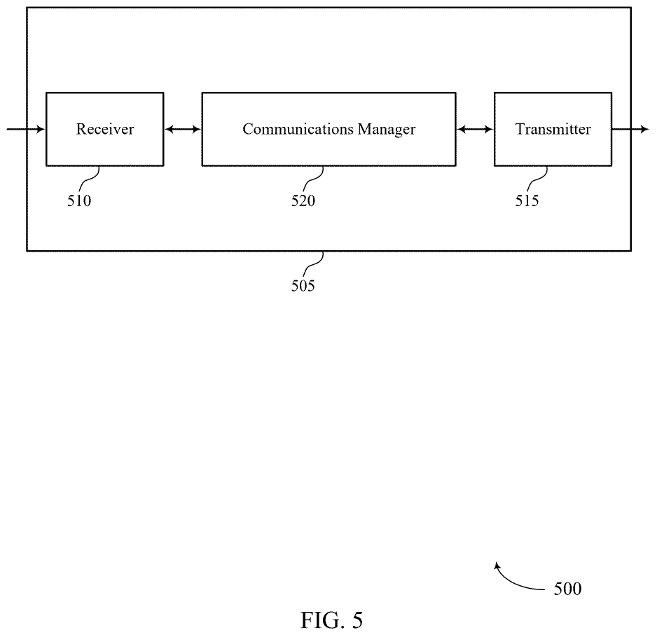

FIG. 5 shows a block diagram 500 of a device 505 that supports techniques for consecutive uplink transmission handling in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to consecutive uplink transmission handling). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to consecutive uplink transmission handling). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of consecutive uplink transmission handling as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry), software (e.g., executed by a processor), or any combination thereof. The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, from a network entity, one or more control messages scheduling a first uplink message via a first set of time resources and a second uplink message via a second set of time resources, where the second set of time resources is physically non-overlapping with the first set of time resources in a time domain. The communications manager 520 is capable of, configured to, or operable to support a means for refraining from transmitting at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap. The communications manager 520 is capable of, configured to, or operable to support a means for transmitting the second uplink message, a second portion of the first uplink message that is virtually non-overlapping with the second uplink message, or both, based on refraining from transmitting the first portion of the first uplink message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources and improved communication reliability.

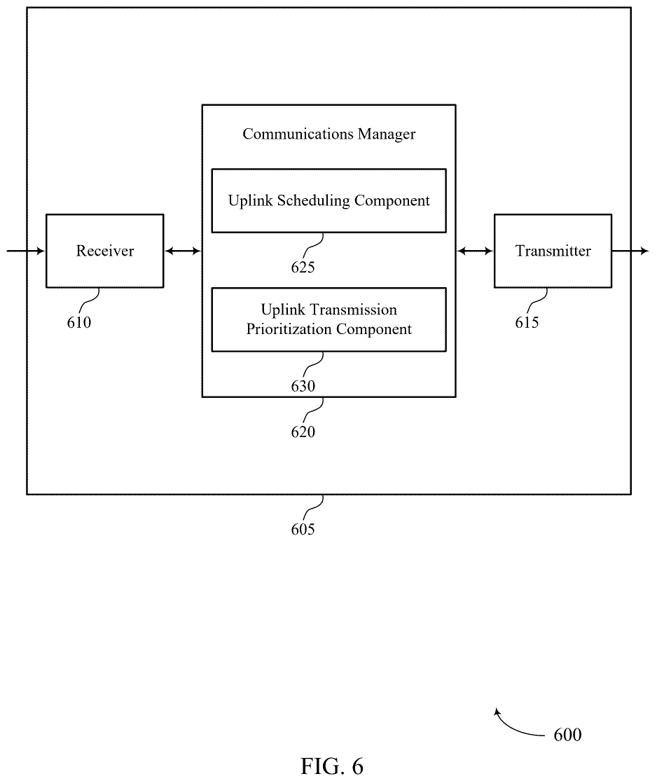

FIG. 6 shows a block diagram 600 of a device 605 that supports techniques for consecutive uplink transmission handling in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to consecutive uplink transmission handling). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to consecutive uplink transmission handling). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of consecutive uplink transmission handling as described herein. For example, the communications manager 620 may include an uplink scheduling component 625 an uplink transmission prioritization component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The uplink scheduling component 625 is capable of, configured to, or operable to support a means for receiving, from a network entity, one or more control messages scheduling a first uplink message via a first set of time resources and a second uplink message via a second set of time resources, where the second set of time resources is physically non-overlapping with the first set of time resources in a time domain. The uplink transmission prioritization component 630 is capable of, configured to, or operable to support a means for refraining from transmitting at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap. The uplink transmission prioritization component 630 is capable of, configured to, or operable to support a means for transmitting the second uplink message, a second portion of the first uplink message that is virtually non-overlapping with the second uplink message, or both, based on refraining from transmitting the first portion of the first uplink message.

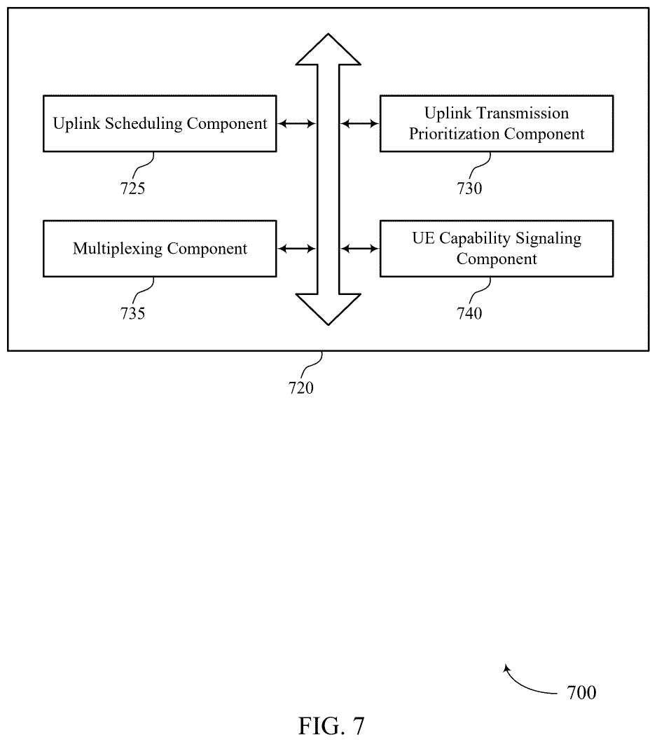

FIG. 7 shows a block diagram 700 of a communications manager 720 that supports techniques for consecutive uplink transmission handling in accordance with one or more aspects of the present disclosure. The communications manager 720 may be an example of aspects of a communications manager 520, a communications manager 620, or both, as described herein. The communications manager 720, or various components thereof, may be an example of means for performing various aspects of consecutive uplink transmission handling as described herein. For example, the communications manager 720 may include an uplink scheduling component 725, an uplink transmission prioritization component 730, a multiplexing component 735, a UE capability signaling component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The uplink scheduling component 725 is capable of, configured to, or operable to support a means for receiving, from a network entity, one or more control messages scheduling a first uplink message via a first set of time resources and a second uplink message via a second set of time resources, where the second set of time resources is physically non-overlapping with the first set of time resources in a time domain. The uplink transmission prioritization component 730 is capable of, configured to, or operable to support a means for refraining from transmitting at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap. In some examples, the uplink transmission prioritization component 730 is capable of, configured to, or operable to support a means for transmitting the second uplink message, a second portion of the first uplink message that is virtually non-overlapping with the second uplink message, or both, based on refraining from transmitting the first portion of the first uplink message. In some examples, the UE refrains from transmitting the first portion of the first uplink message in accordance with a transmission configuration for transmitting temporally-overlapping uplink messages.

In some examples, to support refraining from transmitting at least the first portion of the first uplink message, the uplink transmission prioritization component 730 is capable of, configured to, or operable to support a means for refraining from transmitting at least the first portion of the first uplink message based on a first priority of the first uplink message being less than a second priority of the second uplink message.

In some examples, to support transmitting the second uplink message, the second portion of the first uplink message, or both, the multiplexing component 735 is capable of, configured to, or operable to support a means for multiplexing the second portion of the first uplink message with the second uplink message based on a first priority of the first uplink message being less than a second priority of the second uplink message, where the first uplink message includes an uplink control channel message and the second uplink message includes an uplink shared channel message. In some examples, the UE capability signaling component 740 is capable of, configured to, or operable to support a means for transmitting, to the network entity, capability signaling indicating one or more capabilities of the UE to support transmission of the first uplink message and the second uplink message in accordance with the threshold gap. In some examples, the threshold gap is based on a subcarrier spacing of a channel associated with the first uplink message, the second uplink message, or both.

In some examples, to support transmitting the second uplink message, the second portion of the first uplink message, or both, the uplink transmission prioritization component 730 is capable of, configured to, or operable to support a means for transmitting the second uplink message. In some examples, to support transmitting the second uplink message, the second portion of the first uplink message, or both, the uplink transmission prioritization component 730 is capable of, configured to, or operable to support a means for refraining from transmitting the second portion of the first uplink message that is virtually non-overlapping with the second uplink message.

In some examples, the first uplink message is associated with a first uplink transmission type that supports full dropping of an entirety of the first uplink message. In some examples, refraining from transmitting the second portion of the first uplink message is based on the first uplink message being associated with the first uplink transmission type.

In some examples, the first uplink transmission type further includes an uplink shared channel transmission. In some examples, a first symbol of the uplink shared channel transmission includes a DMRS; an uplink control channel transmission associated with multiple UE scheduling supporting orthogonal covering code in the time domain; or a repetition of a sounding reference signal (SRS) with orthogonal covering code in the time domain.

In some examples, the first uplink message is associated with a second uplink transmission type that supports partial dropping of the first uplink message, and the uplink transmission prioritization component 730 is capable of, configured to, or operable to support a means for transmitting the second portion of the first uplink message based on the first uplink message being associated with the second uplink transmission type. In some examples, the UE refrains from transmitting at least the first portion of the first uplink message based on the first uplink message including an eMBB message and the second uplink message including a URLLC message.

In some examples, the first uplink message occurs prior to the second uplink message in the time domain. In some examples, the first portion of the first uplink message includes an ending portion of the first uplink message. In some examples, the first uplink message occurs subsequent to the second uplink message in the time. In some examples, the first portion of the first uplink message includes a beginning portion of the first uplink message.

In some examples, the first uplink message is associated with a first transmission power at the UE. In some examples, the second uplink message is associated with a second transmission power at the UE. In some examples, the first portion of the first uplink message virtually overlaps with the second uplink message based on a difference between the first transmission power and the second transmission power being greater than a threshold difference.

In some examples, the first uplink message is associated with a first transmit antenna of the UE. In some examples, the second uplink message is associated with a second transmit antenna of the UE. In some examples, first portion of the first uplink message virtually overlaps with the second uplink message based on the first transmit antenna being different from the second transmit antenna.

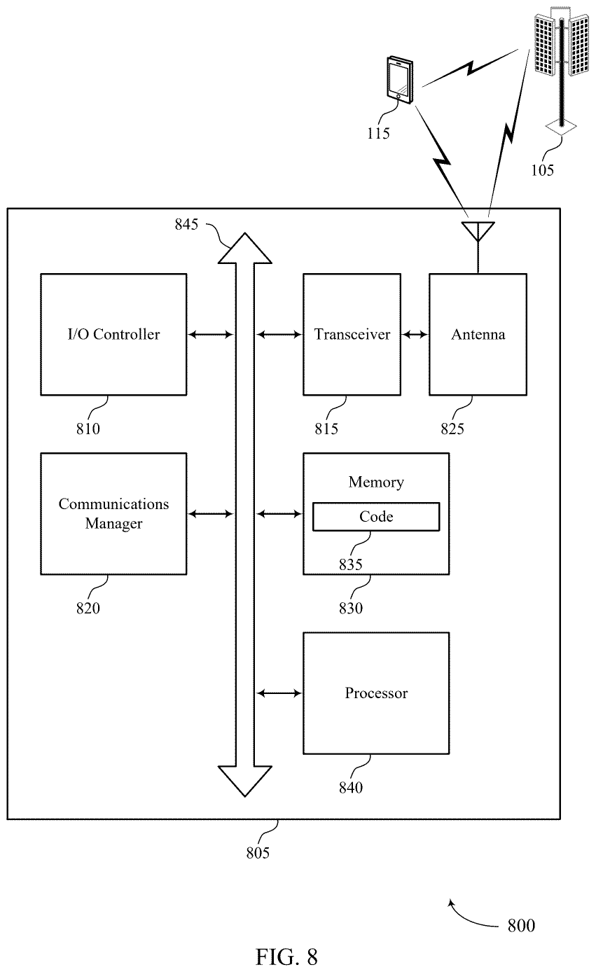

FIG. 8 shows a diagram of a system 800 including a device 805 that supports techniques for consecutive uplink transmission handling in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more NPUs (also referred to as neural network processors or deep learning processors (DLPs)), a GPU, one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting consecutive uplink transmission handling). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, from a network entity, one or more control messages scheduling a first uplink message via a first set of time resources and a second uplink message via a second set of time resources, where the second set of time resources is physically non-overlapping with the first set of time resources in a time domain. The communications manager 820 is capable of, configured to, or operable to support a means for refraining from transmitting at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap. The communications manager 820 is capable of, configured to, or operable to support a means for transmitting the second uplink message, a second portion of the first uplink message that is virtually non-overlapping with the second uplink message, or both, based on refraining from transmitting the first portion of the first uplink message.

By including or configuring the communications manager 820 in accordance with examples as described herein, the device 805 may support techniques for improved communication reliability, reduced latency, more efficient utilization of communication resources, improved coordination between devices, reduced impact due to uplink scheduling conflicts including virtual scheduling conflicts, and increased support for effective uplink transmission for consecutive uplink transmissions having different Tx antennas and/or transmit powers.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of consecutive uplink transmission handling as described herein, or the at least one processor 840 and the at least one memory 830 may be otherwise configured to, individually or collectively, perform or support such operations.

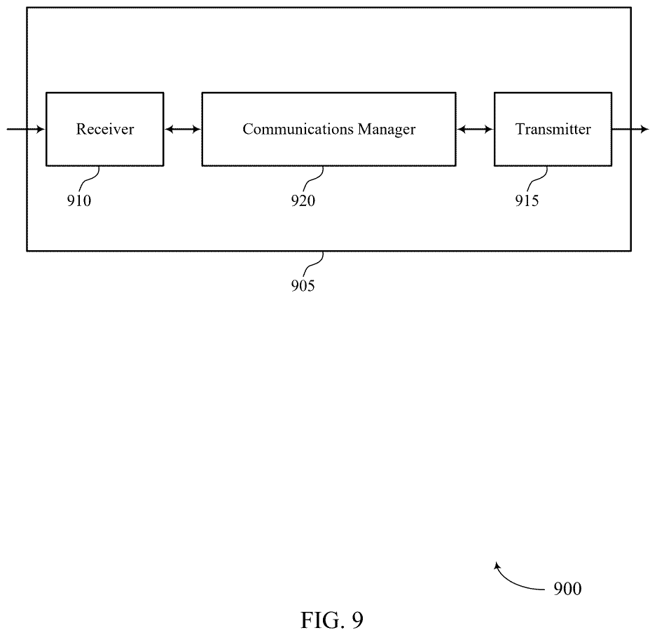

FIG. 9 shows a block diagram 900 of a device 905 that supports techniques for consecutive uplink transmission handling in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of consecutive uplink transmission handling as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry), software (e.g., executed by a processor), or any combination thereof. The hardware may include at least one of a processor, a DSP, a CPU, an NPU, a GPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an NPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting, to a UE, one or more control messages scheduling a first uplink message via a first set of time resources and a second uplink message via a second set of time resources, where the second set of time resources is physically non-overlapping with the first set of time resources in a time domain. The communications manager 920 is capable of, configured to, or operable to support a means for refraining from monitoring for at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap. The communications manager 920 is capable of, configured to, or operable to support a means for obtaining the second uplink message, a second portion of the first uplink message that is virtually non-overlapping with the second uplink message, or both, based on refraining from monitoring for at least the first portion of the first uplink message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources and improved communication reliability.

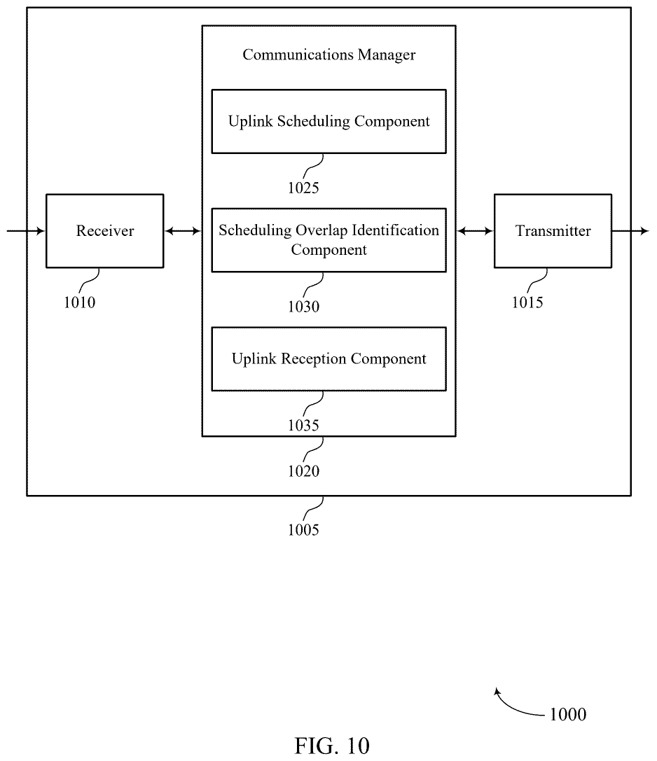

FIG. 10 shows a block diagram 1000 of a device 1005 that supports techniques for consecutive uplink transmission handling in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of consecutive uplink transmission handling as described herein. For example, the communications manager 1020 may include an uplink scheduling component 1025, a scheduling overlap identification component 1030, an uplink reception component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The uplink scheduling component 1025 is capable of, configured to, or operable to support a means for outputting, to a UE, one or more control messages scheduling a first uplink message via a first set of time resources and a second uplink message via a second set of time resources, where the second set of time resources is physically non-overlapping with the first set of time resources in a time domain. The scheduling overlap identification component 1030 is capable of, configured to, or operable to support a means for refraining from monitoring for at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap. The uplink reception component 1035 is capable of, configured to, or operable to support a means for obtaining the second uplink message, a second portion of the first uplink message that is virtually non-overlapping with the second uplink message, or both, based on refraining from monitoring for at least the first portion of the first uplink message.

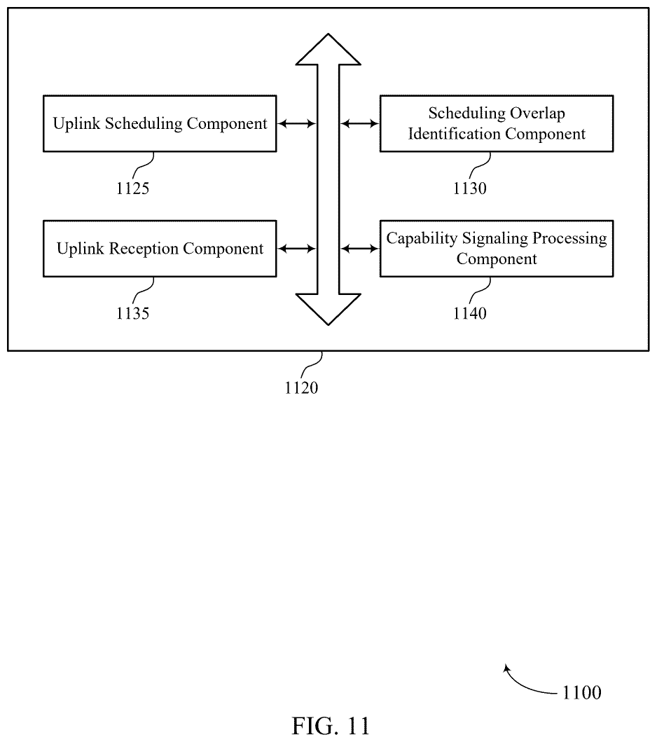

FIG. 11 shows a block diagram 1100 of a communications manager 1120 that supports techniques for consecutive uplink transmission handling in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of consecutive uplink transmission handling as described herein. For example, the communications manager 1120 may include an uplink scheduling component 1125, a scheduling overlap identification component 1130, an uplink reception component 1135, a capability signaling processing component 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The uplink scheduling component 1125 is capable of, configured to, or operable to support a means for outputting, to a UE, one or more control messages scheduling a first uplink message via a first set of time resources and a second uplink message via a second set of time resources, where the second set of time resources is physically non-overlapping with the first set of time resources in a time domain. The scheduling overlap identification component 1130 is capable of, configured to, or operable to support a means for refraining from monitoring for at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap. The uplink reception component 1135 is capable of, configured to, or operable to support a means for obtaining the second uplink message, a second portion of the first uplink message that is virtually non-overlapping with the second uplink message, or both, based on refraining from monitoring for at least the first portion of the first uplink message.

In some examples, the network entity refrains from monitoring for the first portion of the first uplink message in accordance with a transmission configuration for communicating temporally-overlapping uplink messages. In some examples, to support refraining monitoring for at least the first portion of the first uplink message, the scheduling overlap identification component 1130 is capable of, configured to, or operable to support a means for refraining from monitoring for at least the first portion of the first uplink message based on a first priority of the first uplink message being less than a second priority of the second uplink message.

In some examples, to support obtaining the second uplink message, the second portion of the first uplink message, or both, the scheduling overlap identification component 1130 is capable of, configured to, or operable to support a means for obtaining the second portion of the first uplink message that is multiplexed with the second uplink message based on a first priority of the first uplink message being less than a second priority of the second uplink message, where the first uplink message includes an uplink control channel message and the second uplink message includes an uplink shared channel message.

In some examples, the capability signaling processing component 1140 is capable of, configured to, or operable to support a means for obtaining, from the UE, capability signaling indicating one or more capabilities of the UE to support transmission of the first uplink message and the second uplink message in accordance with the threshold gap. In some examples, the threshold gap is based on a subcarrier spacing of a channel associated with the first uplink message, the second uplink message, or both.

In some examples, to support obtaining the second uplink message, the second portion of the first uplink message, or both, the uplink reception component 1135 is capable of, configured to, or operable to support a means for obtaining the second uplink message. In some examples, to support obtaining the second uplink message, the second portion of the first uplink message, or both, the scheduling overlap identification component 1130 is capable of, configured to, or operable to support a means for refraining from monitoring for the second portion of the first uplink message that is virtually non-overlapping with the second uplink message.

In some examples, the first uplink message is associated with a first uplink transmission type that supports full dropping of an entirety of the first uplink message. In some examples, refraining from monitoring for the second portion of the first uplink message is based on the first uplink message being associated with the first uplink transmission type.

In some examples, to support first uplink transmission type, the uplink reception component 1135 is capable of, configured to, or operable to support a means for receiving an uplink shared channel transmission, where a first symbol of the uplink shared channel transmission includes a DMRS; an uplink control channel transmission associated with multiple UE scheduling supporting orthogonal covering code in the time domain; or a repetition of a sounding reference signal with orthogonal covering code in the time domain.

In some examples, the first uplink message is associated with a second uplink transmission type that supports partial dropping of the first uplink message, and the uplink reception component 1135 is capable of, configured to, or operable to support a means for monitoring for the second portion of the first uplink message based on the first uplink message being associated with the second uplink transmission type. In some examples, the network entity refrains from obtaining at least the first portion of the first uplink message based on the first uplink message including an eMBB message and the second uplink message including a URLLC message. In some examples, the first uplink message occurs prior to the second uplink message in the time domain. In some examples, the first portion of the first uplink message includes an ending portion of the first uplink message. In some examples, the first uplink message occurs subsequent to the second uplink message in the time domain. In some examples, the first portion of the first uplink message includes a beginning portion of the first uplink message.

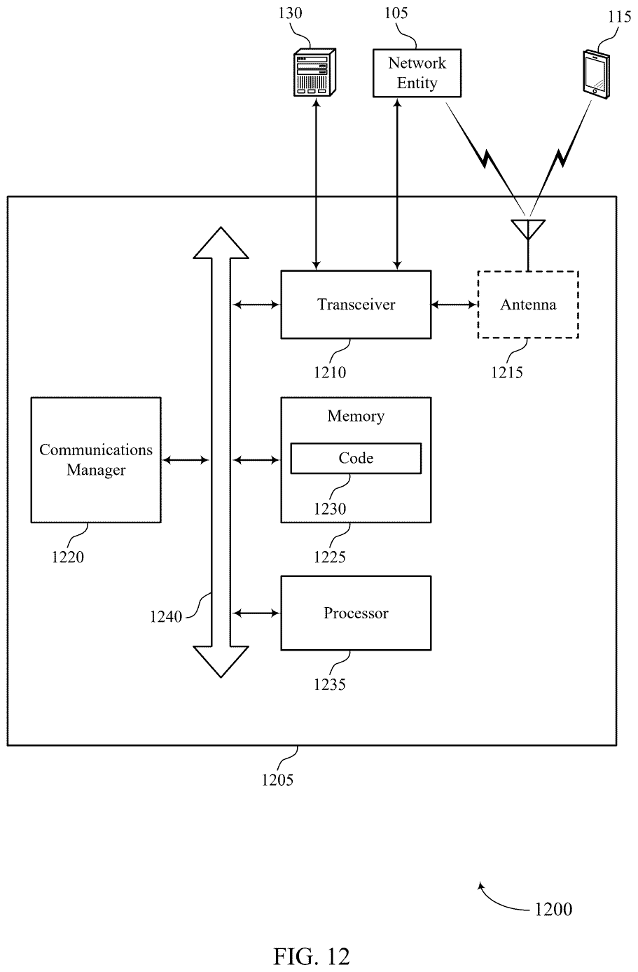

FIG. 12 shows a diagram of a system 1200 including a device 1205 that supports techniques for consecutive uplink transmission handling in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting consecutive uplink transmission handling). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting, to a UE, one or more control messages scheduling a first uplink message via a first set of time resources and a second uplink message via a second set of time resources, where the second set of time resources is physically non-overlapping with the first set of time resources in a time domain. The communications manager 1220 is capable of, configured to, or operable to support a means for refraining from monitoring for at least a first portion of the first uplink message that is virtually overlapping with the second uplink message, where the first portion of the first uplink message virtually overlaps with the second uplink message based on a time gap between the first uplink message and the second uplink message in the time domain being less than a threshold gap. The communications manager 1220 is capable of, configured to, or operable to support a means for obtaining the second uplink message, a second portion of the first uplink message that is virtually non-overlapping with the second uplink message, or both, based on refraining from monitoring for at least the first portion of the first uplink message.

By including or configuring the communications manager 1220 in accordance with examples as described herein, the device 1205 may support techniques for improved communication reliability, reduced latency, more efficient utilization of communication resources, improved coordination between devices, reduced impact due to uplink scheduling conflicts including virtual scheduling conflicts, and increased support for effective uplink transmission for consecutive uplink transmissions having different Tx antennas and/or transmit powers.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of consecutive uplink transmission handling as described herein, or the at least one processor 1235 and the at least one memory 1225 may be otherwise configured to, individually or collectively, perform or support such operations.

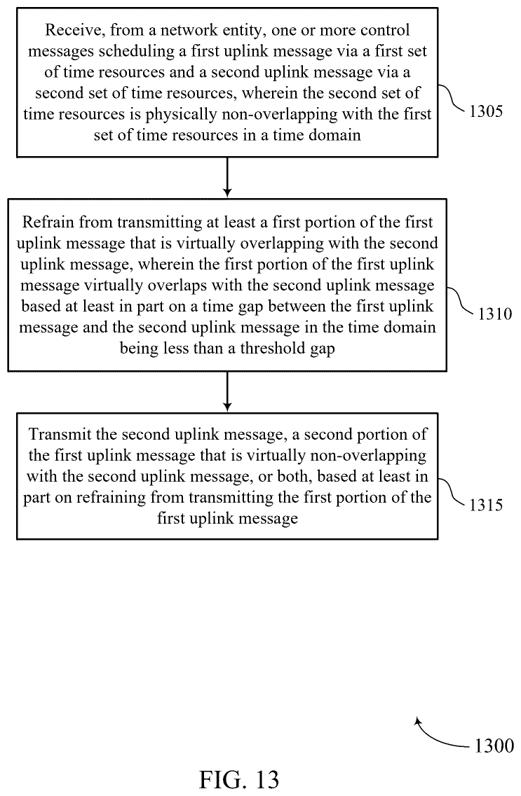

FIG. 13 shows a flowchart illustrating a method 1300 that supports techniques for consecutive uplink transmission handling in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, one or more control messages scheduling a first uplink message via a first set of time resources and a second uplink message via a second set of time resources, wherein the second set of time resources is physically non-overlapping with the first set of time resources in a time domain. The operations of 1305 may be performed in accordance with examples as disclosed herein. In some examples, aspects of the operations of 1305 may be performed by an uplink scheduling component 725 as described with reference to FIG. 7.

At 1310, the method may include refraining from transmitting at least a first portion of the first uplink message that is virtually overlapping with the second uplink message, wherein the first portion of the first uplink message virtually overlaps with the second uplink message based at least in part on a time gap between the first uplink message and the second uplink message in the time domain being less than a threshold gap. The operations of 1310 may be performed in accordance with examples as disclosed herein. In some examples, aspects of the operations of 1310 may be performed by an uplink transmission prioritization component 730 as described with reference to FIG. 7.

At 1315, the method may include transmitting the second uplink message, a second portion of the first uplink message that is virtually non-overlapping with the second uplink message, or both, based at least in part on refraining from transmitting the first portion of the first uplink message. The operations of 1315 may be performed in accordance with examples as disclosed herein. In some examples, aspects of the operations of 1315 may be performed by an uplink transmission prioritization component 730 as described with reference to FIG. 7.

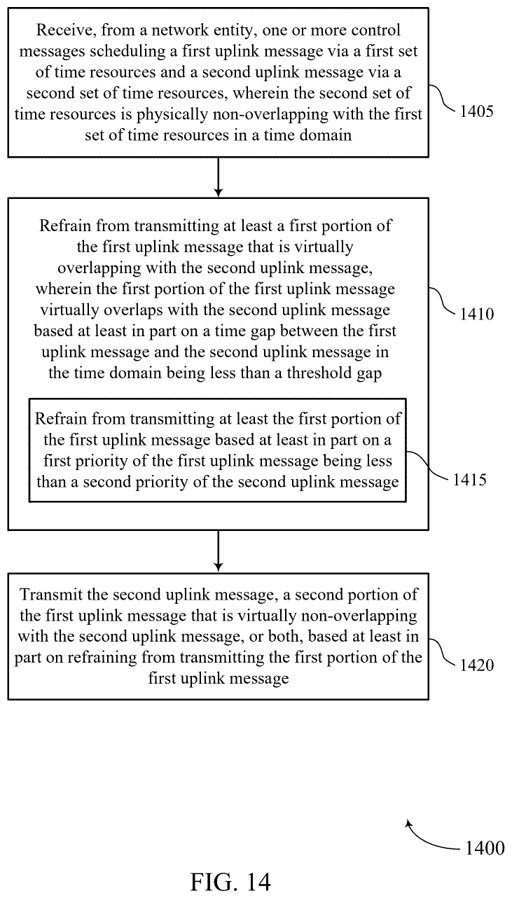

FIG. 14 shows a flowchart illustrating a method 1400 that supports techniques for consecutive uplink transmission handling in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, one or more control messages scheduling a first uplink message via a first set of time resources and a second uplink message via a second set of time resources, wherein the second set of time resources is physically non-overlapping with the first set of time resources in a time domain. The operations of 1405 may be performed in accordance with examples as disclosed herein. In some examples, aspects of the operations of 1405 may be performed by an uplink scheduling component 725 as described with reference to FIG. 7.

At 1410, the method may include refraining from transmitting at least a first portion of the first uplink message that is virtually overlapping with the second uplink message, wherein the first portion of the first uplink message virtually overlaps with the second uplink message based at least in part on a time gap between the first uplink message and the second uplink message in the time domain being less than a threshold gap. The operations of 1410 may be performed in accordance with examples as disclosed herein. In some examples, aspects of the operations of 1410 may be performed by an uplink transmission prioritization component 730 as described with reference to FIG. 7.

At 1415, the method may include refraining from transmitting at least the first portion of the first uplink message based at least in part on a first priority of the first uplink message being less than a second priority of the second uplink message. The operations of 1415 may be performed in accordance with examples as disclosed herein. In some examples, aspects of the operations of 1415 may be performed by an uplink transmission prioritization component 730 as described with reference to FIG. 7.

At 1420, the method may include transmitting the second uplink message, a second portion of the first uplink message that is virtually non-overlapping with the second uplink message, or both, based at least in part on refraining from transmitting the first portion of the first uplink message. The operations of 1420 may be performed in accordance with examples as disclosed herein. In some examples, aspects of the operations of 1420 may be performed by an uplink transmission prioritization component 730 as described with reference to FIG. 7.

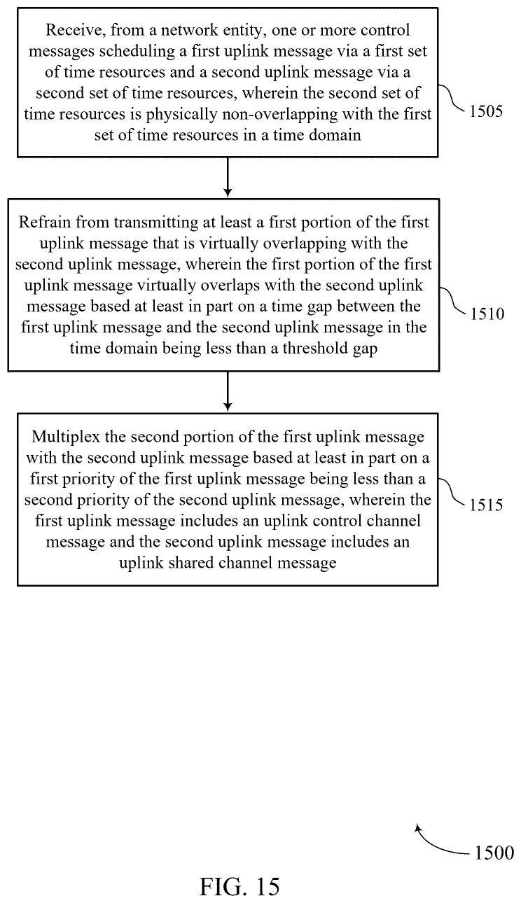

FIG. 15 shows a flowchart illustrating a method 1500 that supports techniques for consecutive uplink transmission handling in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, one or more control messages scheduling a first uplink message via a first set of time resources and a second uplink message via a second set of time resources, wherein the second set of time resources is physically non-overlapping with the first set of time resources in a time domain. The operations of 1505 may be performed in accordance with examples as disclosed herein. In some examples, aspects of the operations of 1505 may be performed by an uplink scheduling component 725 as described with reference to FIG. 7.

At 1510, the method may include refraining from transmitting at least a first portion of the first uplink message that is virtually overlapping with the second uplink message, wherein the first portion of the first uplink message virtually overlaps with the second uplink message based at least in part on a time gap between the first uplink message and the second uplink message in the time domain being less than a threshold gap. The operations of 1510 may be performed in accordance with examples as disclosed herein. In some examples, aspects of the operations of 1510 may be performed by an uplink transmission prioritization component 730 as described with reference to FIG. 7.

At 1515, the method may include multiplexing the second portion of the first uplink message with the second uplink message based at least in part on a first priority of the first uplink message being less than a second priority of the second uplink message, wherein the first uplink message includes an uplink control channel message and the second uplink message includes an uplink shared channel message. The operations of 1515 may be performed in accordance with examples as disclosed herein. In some examples, aspects of the operations of 1515 may be performed by a multiplexing component 735 as described with reference to FIG. 7.

The following provides an overview of aspects of the present disclosure:
Aspect 1: A method for wireless communications at a UE, comprising: receiving, from a network entity, one or more control messages scheduling a first uplink message via a first set of time resources and a second uplink message via a second set of time resources, wherein the second set of time resources is physically non-overlapping with the first set of time resources in a time domain; refraining from transmitting at least a first portion of the first uplink message that is virtually overlapping with the second uplink message, wherein the first portion of the first uplink message virtually overlaps with the second uplink message based at least in part on a time gap between the first uplink message and the second uplink message in the time domain being less than a threshold gap; and transmitting the second uplink message, a second portion of the first uplink message that is virtually non-overlapping with the second uplink message, or both, based at least in part on refraining from transmitting the first portion of the first uplink message.
Aspect 2: The method of aspect 1, wherein the UE refrains from transmitting the first portion of the first uplink message in accordance with a transmission configuration for transmitting temporally-overlapping uplink messages.
Aspect 3: The method of any of aspects 1 through 2, wherein refraining from transmitting at least the first portion of the first uplink message comprises: refraining from transmitting at least the first portion of the first uplink message based at least in part on a first priority of the first uplink message being less than a second priority of the second uplink message.
Aspect 4: The method of any of aspects 1 through 3, wherein transmitting the second uplink message, the second portion of the first uplink message, or both, comprises: multiplexing the second portion of the first uplink message with the second uplink message based at least in part on a first priority of the first uplink message being less than a second priority of the second uplink message, wherein the first uplink message comprises an uplink control channel message and the second uplink message comprises an uplink shared channel message.
Aspect 5: The method of any of aspects 1 through 4, further comprising: transmitting, to the network entity, capability signaling indicating one or more capabilities of the UE to support transmission of the first uplink message and the second uplink message in accordance with the threshold gap.
Aspect 6: The method of any of aspects 1 through 5, wherein the threshold gap is based at least in part on a subcarrier spacing of a channel associated with the first uplink message, the second uplink message, or both.
Aspect 7: The method of any of aspects 1 through 6, wherein transmitting the second uplink message, the second portion of the first uplink message, or both, comprises: transmitting the second uplink message; and refraining from transmitting the second portion of the first uplink message that is virtually non-overlapping with the second uplink message.
Aspect 8: The method of aspect 7, wherein the first uplink message is associated with a first uplink transmission type that supports full dropping of an entirety of the first uplink message, refraining from transmitting the second portion of the first uplink message is based at least in part on the first uplink message being associated with the first uplink transmission type.
Aspect 9: The method of aspect 8, wherein the first uplink transmission type further comprises an uplink shared channel transmission, a first symbol of the uplink shared channel transmission comprises a DMRS; an uplink control channel transmission associated with multiple UE scheduling supporting orthogonal covering code in the time domain; or a repetition of a SRS with orthogonal covering code in the time domain.
Aspect 10: The method of any of aspects 1 through 9, wherein the first uplink message is associated with a second uplink transmission type that supports partial dropping of the first uplink message, the method further comprising: transmitting the second portion of the first uplink message based at least in part on the first uplink message being associated with the second uplink transmission type.
Aspect 11: The method of any of aspects 1 through 10, wherein the UE refrains from transmitting at least the first portion of the first uplink message based at least in part on the first uplink message comprising an eMBB message and the second uplink message comprising an URLLC message.
Aspect 12: The method of any of aspects 1 through 11, wherein the first uplink message occurs prior to the second uplink message in the time domain, the first portion of the first uplink message comprises an ending portion of the first uplink message, or the first uplink message occurs subsequent to the second uplink message in the time, the first portion of the first uplink message comprises a beginning portion of the first uplink message
Aspect 13: The method of any of aspects 1 through 12, wherein the first uplink message is associated with a first transmission power at the UE, and the second uplink message is associated with a second transmission power at the UE, the first portion of the first uplink message virtually overlaps with the second uplink message based at least in part on a difference between the first transmission power and the second transmission power being greater than a threshold difference.
Aspect 14: The method of any of aspects 1 through 13, wherein the first uplink message is associated with a first transmit antenna of the UE, and the second uplink message is associated with a second transmit antenna of the UE, first portion of the first uplink message virtually overlaps with the second uplink message based at least in part on the first transmit antenna being different from the second transmit antenna.
Aspect 15: A method for wireless communications at a network entity, comprising: outputting, to a UE, one or more control messages scheduling a first uplink message via a first set of time resources and a second uplink message via a second set of time resources, wherein the second set of time resources is physically non-overlapping with the first set of time resources in a time domain; refraining from monitoring for at least a first portion of the first uplink message that is virtually overlapping with the second uplink message, wherein the first portion of the first uplink message virtually overlaps with the second uplink message based at least in part on a time gap between the first uplink message and the second uplink message in the time domain being less than a threshold gap; and obtaining the second uplink message, a second portion of the first uplink message that is virtually non-overlapping with the second uplink message, or both, based at least in part on refraining from monitoring for at least the first portion of the first uplink message.
Aspect 16: The method of aspect 15, wherein the network entity refrains from monitoring for the first portion of the first uplink message in accordance with a transmission configuration for communicating temporally-overlapping uplink messages.
Aspect 17: The method of any of aspects 15 through 16, wherein refraining monitoring for at least the first portion of the first uplink message comprises: refraining from monitoring for at least the first portion of the first uplink message based at least in part on a first priority of the first uplink message being less than a second priority of the second uplink message.
Aspect 18: The method of any of aspects 15 through 17, wherein obtaining the second uplink message, the second portion of the first uplink message, or both, comprises: obtaining the second portion of the first uplink message that is multiplexed with the second uplink message based at least in part on a first priority of the first uplink message being less than a second priority of the second uplink message, wherein the first uplink message comprises an uplink control channel message and the second uplink message comprises an uplink shared channel message.
Aspect 19: The method of any of aspects 15 through 18, further comprising: obtaining, from the UE, capability signaling indicating one or more capabilities of the UE to support transmission of the first uplink message and the second uplink message in accordance with the threshold gap.
Aspect 20: The method of any of aspects 15 through 19, wherein the threshold gap is based at least in part on a subcarrier spacing of a channel associated with the first uplink message, the second uplink message, or both.
Aspect 21: The method of any of aspects 15 through 20, wherein obtaining the second uplink message, the second portion of the first uplink message, or both, comprises: obtaining the second uplink message; and refraining from monitoring for the second portion of the first uplink message that is virtually non-overlapping with the second uplink message.
Aspect 22: The method of aspect 21, wherein the first uplink message is associated with a first uplink transmission type that supports full dropping of an entirety of the first uplink message, refraining from monitoring for the second portion of the first uplink message is based at least in part on the first uplink message being associated with the first uplink transmission type.
Aspect 23: The method of aspect 22, wherein the first uplink transmission type further comprises: an uplink shared channel transmission, wherein a first symbol of the uplink shared channel transmission comprises a DMRS; an uplink control channel transmission associated with multiple UE scheduling supporting orthogonal covering code in the time domain; or a repetition of a SRS with orthogonal covering code in the time domain.
Aspect 24: The method of any of aspects 15 through 23, wherein the first uplink message is associated with a second uplink transmission type that supports partial dropping of the first uplink message, the method further comprising: monitoring for the second portion of the first uplink message based at least in part on the first uplink message being associated with the second uplink transmission type.
Aspect 25: The method of any of aspects 15 through 24, wherein the network entity refrains from obtaining at least the first portion of the first uplink message based at least in part on the first uplink message comprising an eMBB message and the second uplink message comprising an URLLC message.
Aspect 26: The method of any of aspects 15 through 25, wherein the first uplink message occurs prior to the second uplink message in the time domain, the first portion of the first uplink message comprises an ending portion of the first uplink message, or the first uplink message occurs subsequent to the second uplink message in the time domain, the first portion of the first uplink message comprises a beginning portion of the first uplink message
Aspect 27: A UE for wireless communications, comprising one or more memories storing processor-executable code, and one or more processors coupled with the one or more memories and individually or collectively operable to execute the code to cause the UE to perform a method of any of aspects 1 through 14.
Aspect 28: A UE for wireless communications, comprising at least one means for performing a method of any of aspects 1 through 14.
Aspect 29: A non-transitory computer-readable medium storing code for wireless communications, the code comprising instructions executable by one or more processors (e.g., directly, indirectly, after pre-processing, without pre-processing) to perform a method of any of aspects 1 through 14.
Aspect 30: A network entity for wireless communications, comprising one or more memories storing processor-executable code, and one or more processors coupled with the one or more memories and individually or collectively operable to execute the code to cause the network entity to perform a method of any of aspects 15 through 26.
Aspect 31: A network entity for wireless communications, comprising at least one means for performing a method of any of aspects 15 through 26.
Aspect 32: A non-transitory computer-readable medium storing code for wireless communications, the code comprising instructions executable by one or more processors (e.g., directly, indirectly, after pre-processing, without pre-processing) to perform a method of any of aspects 15 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Wi-Fi (e.g., Institute of Electrical and Electronics Engineers (IEEE) 802.11), IEEE 802.16 (WiMAX), IEEE 802.20, Flash-OFDM, as well as other systems and radio technologies, including future systems and radio technologies, not explicitly mentioned herein. Components within a wireless communication system may be coupled (for example, operatively, communicatively, functionally, electronically, and/or electrically) to each other.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, one or more control messages scheduling a first uplink message via a first set of time resources and a second uplink message via a second set of time resources, wherein the second set of time resources is physically non-overlapping with the first set of time resources in a time domain;
refrain from transmitting at least a first portion of the first uplink message that is virtually overlapping with the second uplink message, wherein the first portion of the first uplink message virtually overlaps with the second uplink message based at least in part on a time gap between the first uplink message and the second uplink message in the time domain being less than a threshold gap; and
transmit the second uplink message, a second portion of the first uplink message that is virtually non-overlapping with the second uplink message, or both, based at least in part on refraining from transmitting the first portion of the first uplink message.

2. The UE of claim 1, wherein the UE refrains from transmitting the first portion of the first uplink message in accordance with a transmission configuration for transmitting temporally-overlapping uplink messages.

3. The UE of claim 1, wherein, to refrain from transmitting at least the first portion of the first uplink message, the one or more processors are individually or collectively operable to execute the code to cause the UE to:
refrain from transmitting at least the first portion of the first uplink message based at least in part on a first priority of the first uplink message being less than a second priority of the second uplink message.

4. The UE of claim 1, wherein, to transmit the second uplink message, the second portion of the first uplink message, or both, the one or more processors are individually or collectively operable to execute the code to cause the UE to:
multiplex the second portion of the first uplink message with the second uplink message based at least in part on a first priority of the first uplink message being less than a second priority of the second uplink message, wherein the first uplink message comprises an uplink control channel message and the second uplink message comprises an uplink shared channel message.

5. The UE of claim 1, wherein the one or more processors are individually or collectively further operable to execute the code to cause the UE to:
transmit, to the network entity, capability signaling indicating one or more capabilities of the UE to support transmission of the first uplink message and the second uplink message in accordance with the threshold gap.

6. The UE of claim 1, wherein the threshold gap is based at least in part on a subcarrier spacing of a channel associated with the first uplink message, the second uplink message, or both.

7. The UE of claim 1, wherein, to transmit the second uplink message, the second portion of the first uplink message, or both, the one or more processors are individually or collectively operable to execute the code to cause the UE to:
transmit the second uplink message; and
refrain from transmitting the second portion of the first uplink message that is virtually non-overlapping with the second uplink message.

8. The UE of claim 7, wherein the first uplink message is associated with a first uplink transmission type that supports full dropping of an entirety of the first uplink message, wherein refraining from transmitting the second portion of the first uplink message is based at least in part on the first uplink message being associated with the first uplink transmission type.

9. The UE of claim 8, wherein the first uplink transmission type further comprises:
an uplink shared channel transmission, wherein a first symbol of the uplink shared channel transmission comprises a demodulation reference signal;
an uplink control channel transmission associated with multiple UE scheduling supporting orthogonal covering code in the time domain; or
a repetition of a sounding reference signal with orthogonal covering code in the time domain.

10. The UE of claim 1, wherein the first uplink message is associated with a second uplink transmission type that supports partial dropping of the first uplink message, and the one or more processors are individually or collectively further operable to execute the code to cause the UE to:
transmit the second portion of the first uplink message based at least in part on the first uplink message being associated with the second uplink transmission type.

11. The UE of claim 1, wherein the UE refrains from transmitting at least the first portion of the first uplink message based at least in part on the first uplink message comprising an enhanced mobile broadband (eMBB) message and the second uplink message comprising an ultra-reliable low latency communications (URLLC) message.

12. The UE of claim 1,
wherein the first uplink message occurs prior to the second uplink message in the time domain, wherein the first portion of the first uplink message comprises an ending portion of the first uplink message, or
wherein the first uplink message occurs subsequent to the second uplink message in the time domain, wherein the first portion of the first uplink message comprises a beginning portion of the first uplink message.

13. The UE of claim 1, wherein the first uplink message is associated with a first transmission power at the UE, and wherein the second uplink message is associated with a second transmission power at the UE, wherein the first portion of the first uplink message virtually overlaps with the second uplink message based at least in part on a difference between the first transmission power and the second transmission power being greater than a threshold difference.

14. The UE of claim 1, wherein the first uplink message is associated with a first transmit antenna of the UE, and wherein the second uplink message is associated with a second transmit antenna of the UE, wherein the first portion of the first uplink message virtually overlaps with the second uplink message based at least in part on the first transmit antenna being different from the second transmit antenna.

15. A network entity, comprising:
one or more memories storing processor-executable code; and
one or more processors coupled with the one or more memories and individually or collectively operable to execute the code to cause the network entity to:
output, to a user equipment (UE), one or more control messages scheduling a first uplink message via a first set of time resources and a second uplink message via a second set of time resources, wherein the second set of time resources is physically non-overlapping with the first set of time resources in a time domain;
refrain from monitoring for at least a first portion of the first uplink message that is virtually overlapping with the second uplink message, wherein the first portion of the first uplink message virtually overlaps with the second uplink message based at least in part on a time gap between the first uplink message and the second uplink message in the time domain being less than a threshold gap; and
obtain the second uplink message, a second portion of the first uplink message that is virtually non-overlapping with the second uplink message, or both, based at least in part on refraining from monitoring for at least the first portion of the first uplink message.

16. The network entity of claim 15, wherein the network entity refrains from monitoring for the first portion of the first uplink message in accordance with a transmission configuration for communicating temporally-overlapping uplink messages.

17. The network entity of claim 15, wherein, to refrain monitoring for at least the first portion of the first uplink message, the one or more processors are individually or collectively operable to execute the code to cause the network entity to:
refrain from monitoring for at least the first portion of the first uplink message based at least in part on a first priority of the first uplink message being less than a second priority of the second uplink message.

18. The network entity of claim 15, wherein, to obtain the second uplink message, the second portion of the first uplink message, or both, the one or more processors are individually or collectively operable to execute the code to cause the network entity to:
obtain the second portion of the first uplink message that is multiplexed with the second uplink message based at least in part on a first priority of the first uplink message being less than a second priority of the second uplink message, wherein the first uplink message comprises an uplink control channel message and the second uplink message comprises an uplink shared channel message.

19. The network entity of claim 15, wherein the one or more processors are individually or collectively further operable to execute the code to cause the network entity to:
obtain, from the UE, capability signaling indicating one or more capabilities of the UE to support transmission of the first uplink message and the second uplink message in accordance with the threshold gap.

20. The network entity of claim 15, wherein the threshold gap is based at least in part on a subcarrier spacing of a channel associated with the first uplink message, the second uplink message, or both.

21. The network entity of claim 15, wherein, to obtain the second uplink message, the second portion of the first uplink message, or both, the one or more processors are individually or collectively operable to execute the code to cause the network entity to:
obtain the second uplink message; and
refrain from monitoring for the second portion of the first uplink message that is virtually non-overlapping with the second uplink message.

22. The network entity of claim 21, wherein the first uplink message is associated with a first uplink transmission type that supports full dropping of an entirety of the first uplink message, wherein refraining from monitoring for the second portion of the first uplink message is based at least in part on the first uplink message being associated with the first uplink transmission type.

23. The network entity of claim 22, wherein the first uplink transmission type further comprises:
an uplink shared channel transmission, wherein a first symbol of the uplink shared channel transmission comprises a demodulation reference signal;
an uplink control channel transmission associated with multiple UE scheduling supporting orthogonal covering code in the time domain; or
a repetition of a sounding reference signal with orthogonal covering code in the time domain.

24. The network entity of claim 15, wherein the first uplink message is associated with a second uplink transmission type that supports partial dropping of the first uplink message, and the one or more processors are individually or collectively further operable to execute the code to cause the network entity to:
monitor for the second portion of the first uplink message based at least in part on the first uplink message being associated with the second uplink transmission type.

25. The network entity of claim 15, wherein the network entity refrains from obtaining at least the first portion of the first uplink message based at least in part on the first uplink message comprising an enhanced mobile broadband (eMBB) message and the second uplink message comprising an ultra-reliable low latency communications (URLLC) message.

26. The network entity of claim 15,
wherein the first uplink message occurs prior to the second uplink message in the time domain, wherein the first portion of the first uplink message comprises an ending portion of the first uplink message, or
wherein the first uplink message occurs subsequent to the second uplink message in the time domain, wherein the first portion of the first uplink message comprises a beginning portion of the first uplink message.

27. A method for wireless communications at a user equipment (UE), comprising:
receiving, from a network entity, one or more control messages scheduling a first uplink message via a first set of time resources and a second uplink message via a second set of time resources, wherein the second set of time resources is physically non-overlapping with the first set of time resources in a time domain;
refraining from transmitting at least a first portion of the first uplink message that is virtually overlapping with the second uplink message, wherein the first portion of the first uplink message virtually overlaps with the second uplink message based at least in part on a time gap between the first uplink message and the second uplink message in the time domain being less than a threshold gap; and
transmitting the second uplink message, a second portion of the first uplink message that is virtually non-overlapping with the second uplink message, or both, based at least in part on refraining from transmitting the first portion of the first uplink message.

28. The method of claim 27, wherein refraining from transmitting at least the first portion of the first uplink message comprises:
refraining from transmitting at least the first portion of the first uplink message based at least in part on a first priority of the first uplink message being less than a second priority of the second uplink message.

29. The method of claim 27, wherein transmitting the second uplink message, the second portion of the first uplink message, or both, comprises:
multiplexing the second portion of the first uplink message with the second uplink message based at least in part on a first priority of the first uplink message being less than a second priority of the second uplink message, wherein the first uplink message comprises an uplink control channel message and the second uplink message comprises an uplink shared channel message.

30. A method for wireless communications at a network entity, comprising:
outputting, to a user equipment (UE), one or more control messages scheduling a first uplink message via a first set of time resources and a second uplink message via a second set of time resources, wherein the second set of time resources is physically non-overlapping with the first set of time resources in a time domain;
refraining from monitoring for at least a first portion of the first uplink message that is virtually overlapping with the second uplink message, wherein the first portion of the first uplink message virtually overlaps with the second uplink message based at least in part on a time gap between the first uplink message and the second uplink message in the time domain being less than a threshold gap; and
obtaining the second uplink message, a second portion of the first uplink message that is virtually non-overlapping with the second uplink message, or both, based at least in part on refraining from monitoring for at least the first portion of the first uplink message.
